(19) United States
(12) Patent Application Publication
(10) Pub. No.: US 2026/0184088 A1
(43) Pub. Date: Jul. 2, 2026

(54) PRINTING APPARATUS

(71) Applicant: SEIKO EPSON CORPORATION, TOKYO (JP)

(72) Inventor: Seiji IHARA, AZUMINO-SHI (JP)

(21) Appl. No.: 19/432,633

(22) Filed: Dec. 24, 2025

(30) Foreign Application Priority Data
Dec. 27, 2024 (JP) 2024-232761

(51) Int. Cl. B41J 11/00; B41J 29/377

(52) U.S. Cl. CPC B41J 11/00242; B41J 11/0022; B41J 29/377

(57) ABSTRACT

A printing apparatus 1 includes a transport unit 6 that transports a printing medium P, a printing head 3 that performs printing on the printing medium P, and a drying unit 10 disposed downstream of the printing head 3 in a transport direction A. The drying unit 10 includes a plurality of support portions 11 that are arranged side by side with a gap G therebetween along the transport direction A, and heating portions 12 that are provided for each of the plurality of support portions 11 and that heats the support portions 11, and each of the heating portions 12 is capable of individually controlling a heating temperature.

The present application is based on, and claims priority from JP Application Serial Number 2024-232761, filed December 27, 2024, the disclosure of which is hereby incorporated by reference herein in its entirety.

### BACKGROUND

### 1. Technical Field

The present disclosure relates to a printing apparatus.

### 2. Related Art

In the related art, various printing apparatuses that perform printing by ejecting ink onto a printing medium are used. Among these, there is a printing apparatus which is provided with a heating portion which heats a printing medium and is capable of drying ink which is ejected onto the printing medium. For example, JP-A-2024-017168 discloses a printing apparatus having a heating portion in contact with an opposite side of an image forming surface of the printing medium in a drying unit.

JP-A-2024-017168 describes that, in the drying unit, an upstream side (drying unit inlet side) in the transport direction has a higher temperature than a downstream side (drying unit outlet side) in the transport direction. With such a configuration, in a case where an intermittent transport of the printing medium is performed, a temperature distribution of the printing medium when the printing medium is stopped in the drying unit is made uniform, and there is an effect of preventing uneven drying. On the other hand, in a case where the printing medium is continuously transported, the heating portion on the drying unit inlet side, which is to be maintained at a high temperature, contacts the printing medium having the same temperature as the environmental temperature, and thus the amount of heat absorbed by the printing medium is increased. Therefore, the amount of heat required for a heat source is increased, and a large amount of electric power is required.

In addition, in the configuration of JP-A-2024-017168, due to the influence of a temperature decrease on the drying unit inlet side, the temperature of the heating portion on the downstream side thereof also decreases since the heating portion that contacts the printing medium is a single piece in the transport direction of the printing medium, and there are concerns about an increase of load and an increased electric power to be required not only on the drying unit inlet side but also on the heat source on the downstream side thereof. Further, by setting the drying unit inlet side to a high temperature, there is a concern that the drying of the ink surface on the printing medium might rapidly progress in the vicinity of the inlet of the drying unit and a film might be formed on the surface, and the movement of the moisture and the solvent from the inside of liquid droplets might be inhibited, which might conversely prevent the drying, and thus the printing medium might not be efficiently heated.

### SUMMARY

According to an aspect of the present disclosure for solving the above problems, there is provided a printing apparatus including: a transport unit that transports a printing medium in a transport direction; a printing head that performs printing on the printing medium on a transport path of the printing medium; and a drying unit disposed downstream of the printing head in the transport direction. The drying unit includes: a plurality of support portions that are arranged side by side with a gap therebetween along the transport direction and that support the printing medium; and heating portions that are provided for each of the plurality of support portions and that heat the support portions, and each of the heating portions is capable of individually controlling a heating temperature.

### BRIEF DESCRIPTION OF THE DRAWINGS

FIG. 1 is a schematic side view of the printing apparatus according to a first embodiment of the present disclosure.

FIG. 2 is a schematic plan view of heating portions of the printing apparatus of FIG. 1.

FIG. 3 is a schematic side view of the heating portions of the printing apparatus of FIG. 1.

FIG. 4 is a block diagram for explaining a control configuration of the heating portions of the printing apparatus of FIG. 1.

FIG. 5 is a schematic plan view of the heating portions of the printing apparatus according to a second embodiment of the present disclosure.

FIG. 6 is a schematic side view of the heating portions of the printing apparatus of FIG. 5.

FIG. 7 is a schematic plan view of the heating portions of the printing apparatus according to a third embodiment of the present disclosure.

FIG. 8 is a schematic plan view of the heating portion of the printing apparatus of a reference example.

### DESCRIPTION OF EMBODIMENTS

First, the present disclosure will be schematically described.

According to a first aspect of the present disclosure for solving the above problem, there is provided a printing apparatus including: a transport unit that transports a printing medium in a transport direction; a printing head that performs printing on the printing medium on a transport path of the printing medium; and a drying unit disposed downstream of the printing head in the transport direction. The drying unit includes: a plurality of support portions that are arranged side by side with a gap therebetween along the transport direction and that support the printing medium; and heating portions that are provided for each of the plurality of support portions and that heat the support portions, and each of the heating portions is capable of individually controlling a heating temperature.

According to the present aspect, the printing apparatus includes the drying unit, and the drying unit includes: the plurality of support portions that are arranged side by side with the gap therebetween along the transport direction and that support the printing medium; and the heating portions that are provided for each of the plurality of support portions and that heat the support portions, and each of the heating portions is capable of individually controlling a heating temperature. With such a configuration, it is possible to set each heating portion to a desired heating temperature while suppressing heat of the heating portions from escaping to adjacent support portions. Therefore, it is possible to efficiently heat the printing medium while suppressing an increase in a driving power of the heating portions.

According to a second aspect of the present disclosure, which is dependent on the first aspect, the printing apparatus includes a control unit capable of controlling the transport unit and the heating portions. The plurality of support portions include a first support portion disposed on the transport path, and a second support portion disposed downstream of the first support portion in the transport direction on the transport path. The heating portions include a first heating portion that heats the first support portion, and a second heating portion that heats the second support portion. The control unit controls the transport unit such that the transport unit continuously transports the printing medium, and controls the heating portions such that a heating temperature of the first heating portion is lower than a heating temperature of the second heating portion.

According to the present aspect, when the printing medium is continuously transported, the heating temperature of the first heating portion upstream in the transport direction is lower than the heating temperature of the second heating portion downstream in the transport direction. With such a configuration, for example, in the vicinity of the inlet of the drying unit, even when a large amount of heat is absorbed by the printing medium due to a contact with the printing medium having the same temperature as the environmental temperature, since the heating temperature of the first heating portion is set to be low, it is possible to suppress the amount of heat required for the heating portion to raise the temperature of the first heating portion to a target temperature, and the necessity of large electric power can be suppressed.

In the printing apparatus according to a third aspect of the present disclosure, which is dependent on the first or second aspect, the drying unit includes an air blowing unit that blows air from an air blowing port to a printing surface of the printing medium on which printing has been performed by the printing head, and a suction unit in which a suction port is disposed downstream of the air blowing port in the transport direction on the transport path.

According to the present aspect, the drying unit includes the air blowing unit that blows air from the air blowing port to the printing surface of the printing medium on which printing has been performed by the printing head, and the suction unit in which the suction port is disposed downstream of the air blowing port in the transport direction on the transport path. With such a configuration, it is possible to dry the printing medium not only by the heat of the heating portions but also by an airflow, and the printing medium can be dried efficiently.

In the printing apparatus according to a fourth aspect of the present disclosure, which is dependent on the third aspect, the air blowing port and the suction port are disposed to be wider than a width of the printing medium in the width direction intersecting the transport direction.

According to the present aspect, the air blowing port and the suction port are disposed to be wider than the width of the printing medium in the width direction. With such a configuration, it is possible to efficiently blow air to the printing medium, and the printing medium can be dried with particular efficiency.

In the printing apparatus according to a fifth aspect of the present disclosure, which is dependent on the fourth aspect, the air blowing unit includes an airflow heating unit that heats an airflow for blowing toward the printing surface, and blows a heated airflow from the air blowing port.

According to the present aspect, the air blowing unit includes the airflow heating unit that heats the airflow for blowing toward the printing surface, and blows the heated airflow from the air blowing port. With such a configuration, it is possible to blow the heated air to the printing medium, and the printing medium can be dried with particular efficiency.

In the printing apparatus according to a sixth aspect of the present disclosure, which is dependent on any one of the first to fifth aspects, the heating portions are polyimide heaters.

According to the present aspect, the heating portions are polyimide heaters. With such a configuration, the size and cost of the heating portions can be reduced.

### First Embodiment

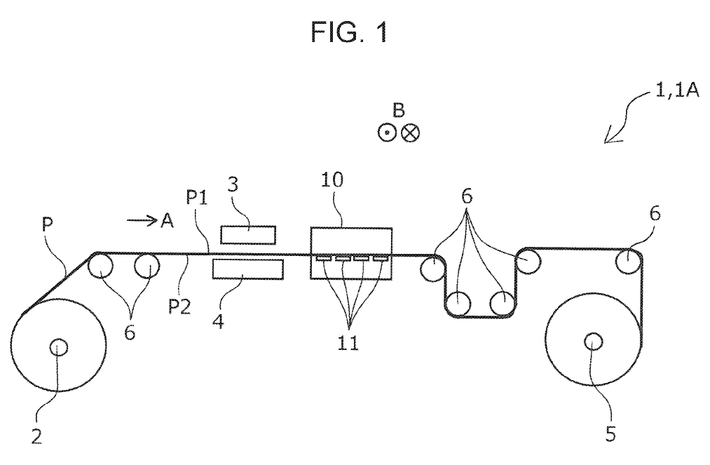

Hereinafter, embodiments of the present disclosure will be described in detail with reference to the drawings. First, an outline of a printing apparatus 1A according to the first embodiment as an example of a printing apparatus 1 of the present disclosure will be described with reference to FIG. 1.

As illustrated in FIG. 1, the printing apparatus 1A of the embodiment includes a setting unit 2 that sets a roll-shaped printing medium P, a winding unit 5 that winds the printing medium P transported from the setting unit 2, and a printing head 3 that forms an image by ejecting ink onto a printing surface P1 of the printing medium P transported in a transport direction A on a transport path from the setting unit 2 to the winding unit 5. The printing apparatus 1A also includes a platen 4 that supports the printing medium P in an image forming region where an image is formed by the printing head 3, a drying unit 10 for drying the ink that has landed on the printing surface P1, and a plurality of transport rollers 6 that are provided on the transport path of the printing medium P and that serve as a transport unit for the printing medium P.

The printing head 3 is provided on a side facing the printing surface P1 of the printing medium P transported in the transport direction A, and forms an image by ejecting ink onto the printing surface P1 in a state in which the support surface P2 on the opposite side to the printing surface P1 of the printing medium P is supported by the platen 4. Here, a configuration of the printing head 3 is not particularly limited. Note that the printing head 3 in the present embodiment is a so-called line head in which nozzles ejecting the ink are arranged along the width direction B over the entire width direction B of the printing medium P and printing is performed in a state where the printing head is stopped. Since the printing head 3 of the present embodiment has such a configuration, it is possible in the printing apparatus 1A of the present embodiment that the printing medium P is continuously transported by the transport rollers 6 and printing is performed by the printing head 3.

As shown in FIG. 1, on the transport path of the printing medium P, the drying unit 10 which dries the ink ejected onto the printing medium P is provided downstream of the printing head 3 in the transport direction A. That is, the printing apparatus 1A of the present embodiment includes the transport rollers 6 which transport the printing medium P in the transport direction A, the printing head 3 which performs printing on the printing medium P on the transport path of the printing medium P, and the drying unit 10 disposed downstream of the printing head 3 in the transport direction A.

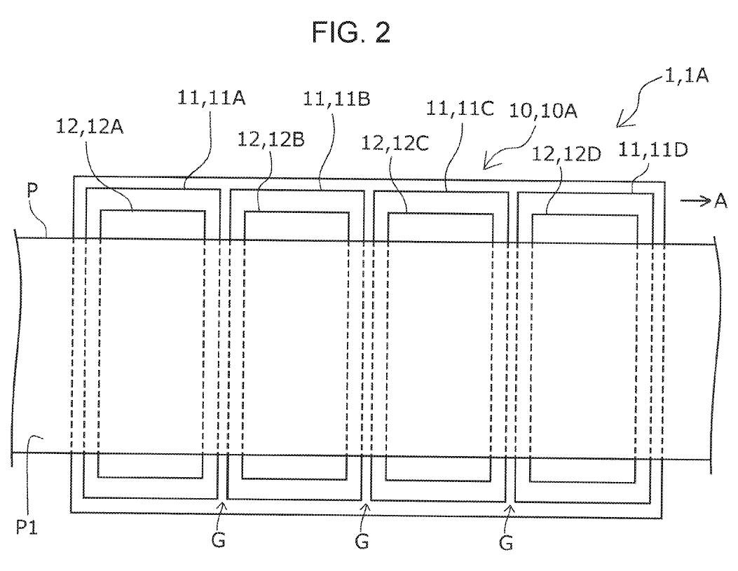

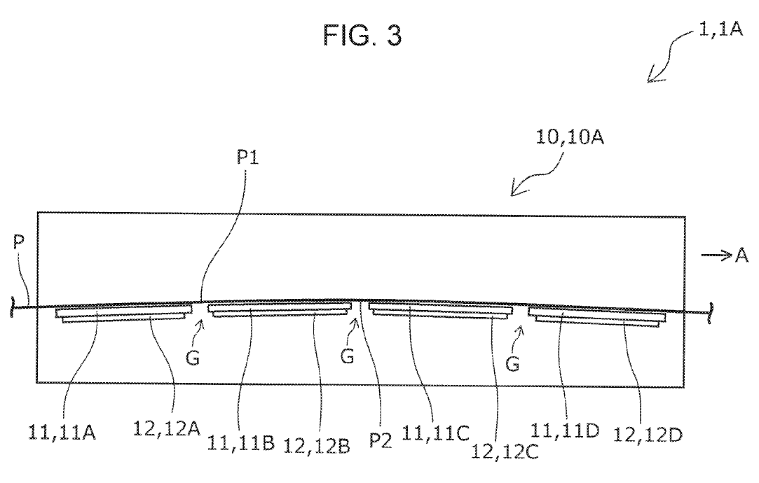

Hereinafter, the drying unit 10 which is a main portion of the printing apparatus 1A of the present embodiment will be described in detail with reference to FIGS. 2 to 4. As shown in FIGS. 2 and 3, a drying unit 10A of the printing apparatus 1A according to the present embodiment includes a plurality of support portions 11 that are arranged side by side with a gap G therebetween along the transport direction A and that support the printing medium P. Specifically, the drying unit 10A has a support portion 11A, a support portion 11B, a support portion 11C, and a support portion 11D. Furthermore, the drying unit 10A includes heating portions 12 that are provided for each of the plurality of support portions 11 and that heat the support portions 11.

Specifically, the support portion 11A includes a heating portion 12A, the support portion 11B includes a heating portion 12B, the support portion 11C includes a heating portion 12C, and the support portion 11D includes a heating portion 12D. Here, each heating portion 12 is capable of individually controlling a heating temperature. Note that, in the printing apparatus 1A of the present embodiment, the number of the support portions 11 and the heating portions 12 is four each, but the number thereof is not particularly limited as long the number of the support portions 11 and the heating portions 12 is plural. In addition, having a gap G is not limited to have a space between the support portions 11, but means that a heat insulating material or the like can be disposed between the support portions 11.

Since the printing apparatus 1A of the present embodiment has such a configuration, it is possible to set each heating portion 12 to a desired heating temperature while suppressing heat of the heating portions 12 from escaping to adjacent support portions 11. Therefore, the printing apparatus 1A according to the present embodiment can efficiently heat the printing medium P while suppressing an increase in a driving power of the heating portions 12. As shown in FIG. 3, in the printing apparatus 1A of the present embodiment, the support portions 11 are configured in an arc shape, but without being limited to such a configuration, the support portions 11 may be configured in a flat shape. However, it is preferable that the support portions 11 are configured in an arc shape since adhesiveness of the support portions 11 to the printing medium P is improved by the arc shape configuration of the support portions 11.

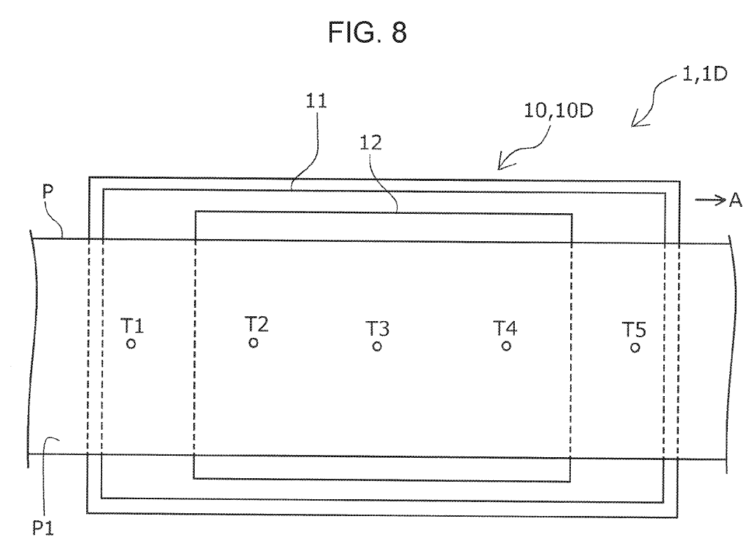

Here, a drying unit 10D in a printing apparatus 1D of a reference example having one support portion 11 and one heating portion 12 as a drying unit 10 will be described with reference to FIG. 8. Note that the printing apparatus 1D of the reference example has the same configuration as the printing apparatus 1A of the present embodiment except for the configuration of the drying unit 10. In the drying unit 10D of the printing apparatus 1D of the reference example, in a case where the printing medium P is continuously transported, due to a contact with the printing medium P having the same temperature as the environment temperature, an amount of heat absorbed by the printing medium P is increased on the inlet side of the drying unit 10D. When temperatures at temperature measurement points T1, T2, T3, T4, and T5 shown in FIG. 8 are measured, the temperatures of the surface of the support portion 11 start to decrease at all the temperature measurement points with the start of transportation and become substantially constant after a lapse of a certain time.

However, this temperature change (temperature decrease) differs depending on an area on the support portion 11. That is, temperatures drop largely from the inlet side to the vicinity of the center, corresponding to from the temperature measurement points T1 to T3, but the temperature drop is reduced from the vicinity of the center to the outlet side, corresponding from the temperature measurement points T3 to T5, and there is almost no temperature drop after the temperature measurement point T4, which is a region of about one-third from the outlet side. This means that, when all of set temperatures of the heating portion 12 are uniform, the heating portion 12 is to be operated at, for example, substantially 100% from the inlet side of the drying unit 10D up to around the region of about one-third from the outlet side. If such an operation is performed, the load of the heating portion 12 is increased, and the power consumption is also increased. On the other hand, by adopting a configuration in which the heating portion 12 is divided into separate portions capable of being independently driven, such as the one in the printing apparatus 1A of the present embodiment, the load of the heating portion 12 can be reduced and the power consumption can also be suppressed to be low, after the region of about one-third from the outlet side.

Further, as the printing apparatus 1D in the reference example, in a case of a configuration in which the support portion 11 is a single-piece configuration, that is, a configuration in which the support portion 11 is not divided in the transport direction A, the heat emitted from the heating portion 12 flows to adjacent regions in the support portion 11. For this reason, even if an attempt is made to set adjacent regions to different temperatures, the heat is transferred to the adjacent regions and the temperature does not reach a set temperature as planned. For example, if a temperature of an adjacent region is set to be lower than a target region, the heating portion 12 of the target region also supplies heat to the adjacent region in order to reduce a temperature difference between the target region and the adjacent region, and thus more electric power than originally required is to be consumed.

In a case where the heating portion 12 can be set to different temperatures in different regions of the support portion 11, even if the heating portion 12 is driven such that different regions of the support portion 11 are set to have the same set temperature, the maintainable temperature is low in the region on the inlet side of the drying unit 10, corresponding to the temperature measurement point T1, for example, and the maintainable temperature is high in the region on the outlet side, corresponding to the temperature measurement point T5, for example. Therefore, by adopting a configuration in which the support portion 11 and the heating portion 12 are divided and each heating portion 12 can be independently driven as those in the printing apparatus 1A of the present embodiment, and by setting a set temperature at the inlet side of the drying unit 10 to a degree such that the amount of heat absorbed by the transported printing medium P and the amount of heat supplied from the heating portion 12 are balanced, it is possible to prevent the heating portion 12 (heating portion 12A) on the inlet side from being overloaded and to reduce power consumption.

Furthermore, with such a configuration, it is not necessary to install a heating portion 12 having a large output on the inlet side. This also leads to a reduction in power consumption. The temperature of the heating portion 12D on the downstream side may be set for maintaining the temperature of the region where the heating portion 12D is disposed and for ensuring the drying capacity. Since the heating portion 12D on the downstream side has a higher maintainable temperature than the other heating portions 12A, 12B, and 12C, even when set temperatures are increased toward the downstream side in the order of the heating portions 12A, 12B, 12C, and 12D, it is possible to achieve both a reduction of the load of the heating portion 12 and securing a drying capability.

Again, in the drying unit 10D in the printing apparatus 1D of the reference example, there is a possibility that the load of the heating portion 12 becomes excessive. In addition, since the heating portion 12 which comes into contact with the printing medium P is a single piece in the transport direction A of the printing medium P, due to the influence of a temperature decrease on the inlet side of the drying unit 10, the temperature on the downstream side thereof also decreases, and there is a concern that increases in the load and necessary power of the heating portion 12 may be caused. Further, by setting the inlet side of the drying unit 10 to a high temperature, there is a concern that the drying of the surface of the ink on the printing medium P might rapidly progress in the vicinity of the inlet of the drying unit 10 and a film might be formed on the surface of the ink, and the movement of the moisture and the solvent from the inside of the ink might be inhibited, which might conversely prevent the drying. On the other hand, in the printing apparatus 1A according to the present embodiment, each of the support portions 11 is provided with the gap G therebetween and each of the heating portions 12 is capable of individually controlling a heating temperature, and therefore power consumption can be reduced, and the printing medium P can be efficiently heated while suppressing the generation of ink films.

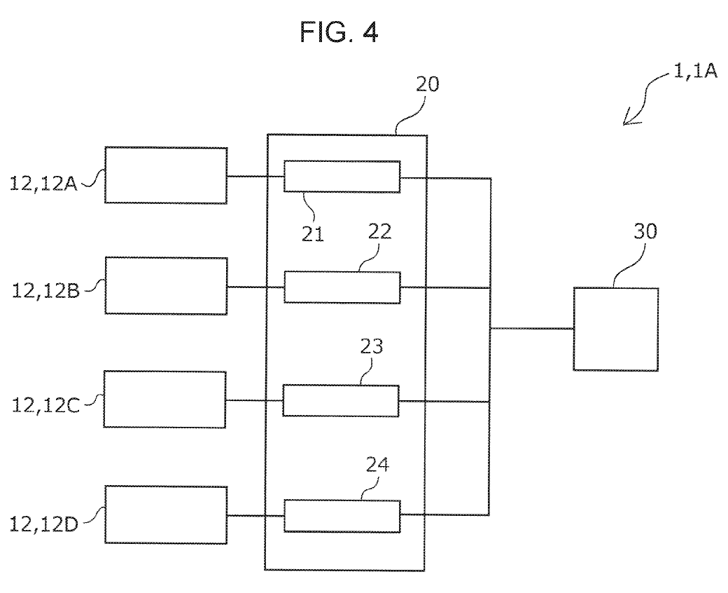

Here, as shown in FIG. 4, the printing apparatus 1A of the present embodiment includes a control unit 20 capable of controlling the transport rollers 6 and the heating portions 12. The control unit 20 can control the transport rollers 6 such that the transport rollers 6 continuously transport the printing medium P. In addition, the plurality of support portions 11 are provided in the printing apparatus 1A as described above, and the plurality of support portions 11 can be expressed as having a first support portion (for example, the support portion 11A)

disposed on the transport path, and a second support portion (for example, the support portion 11B, 11C, or 11D) disposed downstream of the first support portion in the transport direction on the transport path. The heating portions 12 can be expressed as having a first heating portion (for example, the heating portion 12A) that heats the first support portion, and a second heating portion (for example, the heating portion 12B, 12C, or 12D) that heats the second support portion.

As shown in FIG. 4, the control unit 20 includes a temperature control unit 21 for controlling a temperature of the heating portion 12A, a temperature control unit 22 for controlling a temperature of the heating portion 12B, a temperature control unit 23 for controlling a temperature of the heating portion 12C, and a temperature control unit 24 for controlling a temperature of the heating portion 12D, each of which is connected to a power supply 30. With such a configuration, the control unit 20 can individually control the temperatures of each heating portion 12. In other words, the control unit 20 can control the transport rollers 6 such that the transport rollers 6 continuously transport the printing medium P, and can control the heating portions 12 such that the heating temperature of the first heating portion (for example, the heating portion 12A) is lower than the heating temperature of the second heating portion (for example, the heating portion 12B, 12C, or 12D).

Since the printing apparatus 1A of the present embodiment has such a configuration, for example, in the vicinity of the inlet of the drying unit 10A, it is possible to reduce the amount of heat absorbed by the printing medium P due to a contact between the printing medium P, having the same temperature as the environment temperature, and the support portion 11 (support portion 11A). In addition, it is possible to suppress the amount of heat to be required for the heating portions 12 and to suppress the necessity of a large amount of electric power. However, in the printing apparatus 1A of the present embodiment, the control unit 20 can control the heating portions 12 such that the heating temperature of the first heating portion (for example, the heating portion 12A) is higher than the heating temperature of the second heating portion (for example, the heating portion 12B, 12C, or 12D) depending on the type of printing medium P, printing conditions, or the like.

In the printing apparatus 1A of the present embodiment, each of the heating portions 12 is a polyimide heater. By configuring the heating portions 12 as described above, it is possible to reduce a size and cost of the heating portions 12. However, the heating portions 12 are not limited to the polyimide heater, and various other configurations can be used.

### Second Embodiment

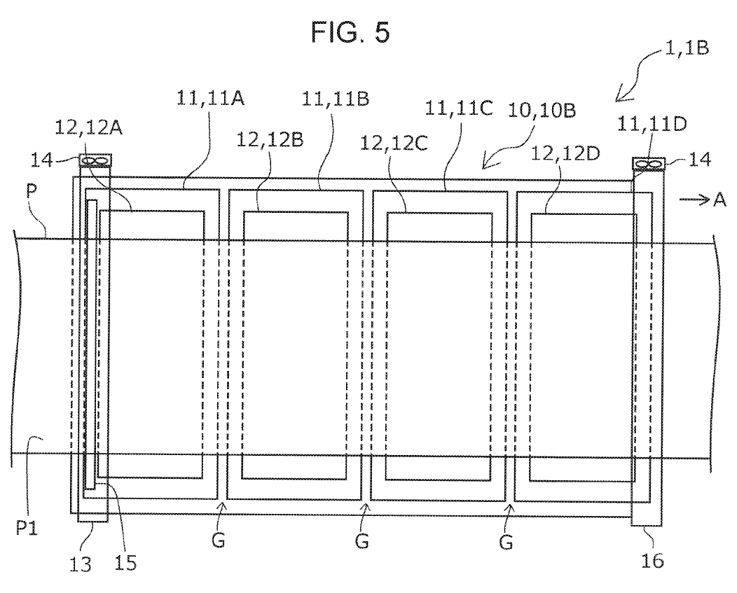

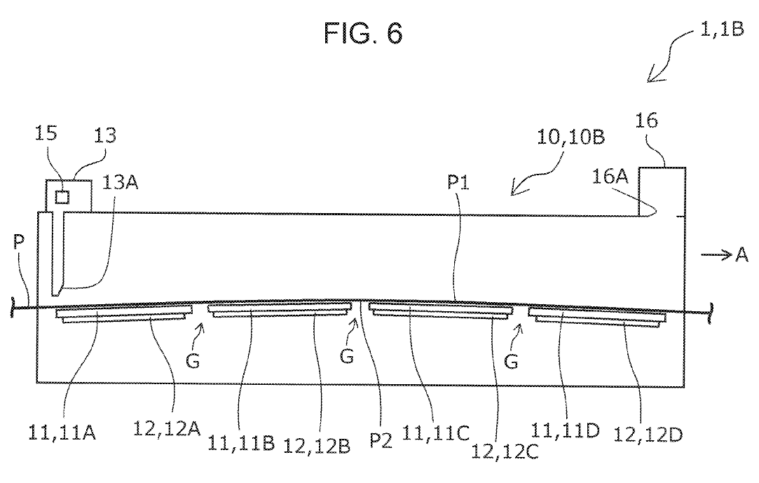

Next, a printing apparatus 1B according to the second embodiment will be described with reference to FIGS. 5 and 6. FIG. 5 is a diagram corresponding to FIG. 2 in the printing apparatus 1A of the first embodiment, and FIG. 6 is a diagram corresponding to FIG. 3 in the printing apparatus 1A of the first embodiment. In FIGS. 5 and 6, the same components as those of the first embodiment are denoted by the same reference numerals, and detailed description thereof will be omitted. Here, the printing apparatus 1B of the present embodiment has the same configuration as the printing apparatus 1A of the first embodiment except for the configuration of the drying unit 10 (drying unit 10B). Accordingly, the printing apparatus 1B of the present embodiment has the same features as those of the printing apparatus 1A of the first embodiment except for the portions described below.

As shown in FIGS. 5 and 6, in the printing apparatus 1B of the present embodiment, the drying unit 10B includes a fan 14, and an air blowing unit 13 that blows air from an air blowing port 13A to the printing surface P1 of the printing medium P on which printing has been performed by the printing head 3. In addition, as shown in FIGS. 5 and 6, the drying unit 10B includes a fan 14, and a suction unit 16 in which a suction port 16A is disposed downstream of the air blowing port 13A in the transport direction A on the transport path of the printing medium P. With such a configuration, the printing apparatus 1B of the present embodiment can dry the printing medium P not only by the heat of the heating portions 12 but also by an airflow, and can dry the printing medium P efficiently.

Here, in the printing apparatus 1B according to the present embodiment, both the air blowing port 13A and the suction port 16A are disposed to be wider than a width of the printing medium P in the width direction B intersecting the transport direction A. Since the printing apparatus 1B of the present embodiment has such a configuration, it is possible to efficiently blow air to the printing medium P, and the printing medium P can be dried with particular efficiency.

In addition, as shown in FIGS. 5 and 6, in the printing apparatus 1B of the present embodiment, the air blowing unit 13 includes an airflow heating unit 15 that heats the airflow for blowing toward the printing surface P1. Thus, the printing apparatus 1B of the present embodiment is configured to be able to blow a heated airflow from the air blowing port 13A. Since the printing apparatus 1B of the present embodiment has such a configuration, it is possible to blow a heated air to the printing medium P, and to dry the printing medium P with particular efficiency.

### Third Embodiment

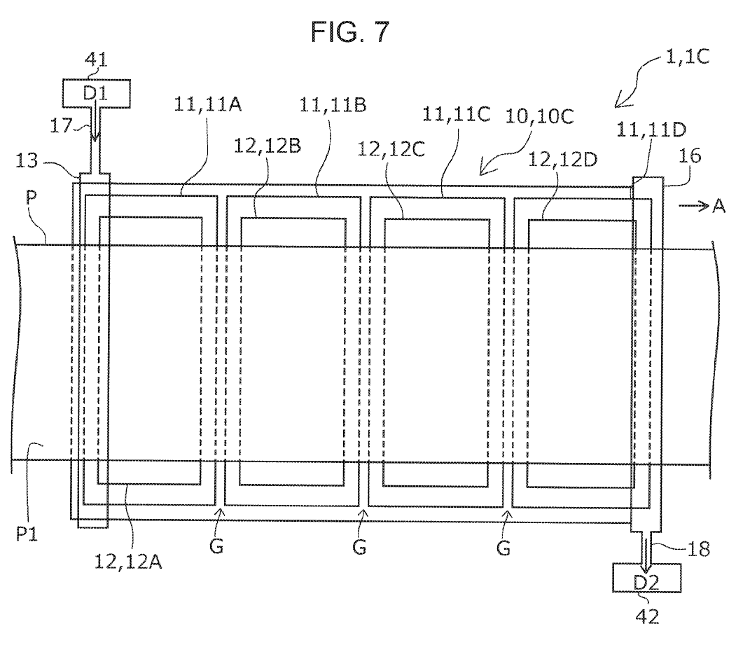

Next, a printing apparatus 1C according to the third embodiment will be described with reference to FIG. 7. FIG. 7 is a diagram corresponding to FIG. 2 in the printing apparatus 1 according to the first embodiment. In FIG. 7, the same components as those of the first and second embodiments are denoted by the same reference numerals, and detailed description thereof will be omitted. Here, the printing apparatus 1C of the present embodiment has the same configuration as the printing apparatus 1 of the first embodiment and the second embodiment except for the configuration of the drying unit 10C. Accordingly, the printing apparatus 1C of the present embodiment has the same features as those of the printing apparatus 1 of the first embodiment and the second embodiment except for the portions described below.

As described above, the printing apparatus 1B of the second embodiment includes the fans 14 in the air blowing unit 13 and the suction unit 16, and is configured to be capable of blowing and sucking air by driving the fans 14. On the other hand, the printing apparatus 1C of the present embodiment is connected to a heated air blowing device 41 and a suction device 42 which are both external devices. Specifically, as shown in FIG. 7, the air blowing unit 13 is connected to the heated air blowing device 41, and the suction unit 16 is connected to a suction device 42. The air blowing unit 13 and the suction unit 16 of the printing apparatus 1C of the present embodiment have substantially the same configuration as the air blowing unit 13 and the suction unit 16 of the printing apparatus 1B of the second embodiment, except that the fans 14 and the airflow heating unit 15 are not included.

The air blowing unit 13 of the printing apparatus 1C of the present embodiment has a configuration in which a heated airflow is sent from the heated air blowing device 41 in the direction D1 via a connection pipe 17 and can be blown to the printing surface P1 of the printing medium P. In addition, the suction unit 16 of the printing apparatus 1C of the present embodiment is configured such that an exhaust air (air in the drying unit 10C) is sent to the suction device 42 in the direction D2 via the connection pipe 18. With such a configuration, the printing apparatus 1C of the present embodiment has the same effect as the printing apparatus 1B of the second embodiment.

The present disclosure is not limited to the above-described embodiments, and can be realized in various configurations without departing from the scope of the present disclosure. For example, the technical features in the embodiments corresponding to the technical features in each aspect described in the summary of the disclosure can be appropriately replaced or combined in order to solve a part or all of the problems described above or in order to achieve a part or all of the effects described above. In addition, when the technical features are not described as essential in the present specification, the technical features can be appropriately deleted.

What is claimed is:

1. A printing apparatus comprising:
a transport unit that transports a printing medium in a transport direction;
a printing head that performs printing on the printing medium on a transport path of the printing medium; and
a drying unit disposed downstream of the printing head in the transport direction, wherein
the drying unit includes:
a plurality of support portions that are arranged side by side with a gap therebetween along the transport direction and that support the printing medium; and
heating portions that are provided for each of the plurality of support portions and that heat the support portions, and
each of the heating portions is capable of individually controlling a heating temperature.

2. The printing apparatus according to claim 1, further comprising:
a control unit capable of controlling the transport unit and the heating portions, wherein
the plurality of support portions include:
a first support portion disposed on the transport path; and
a second support portion disposed downstream of the first support portion in the transport direction on the transport path,
the heating portions include:
a first heating portion that heats the first support portion; and
a second heating portion that heats the second support portion, and
the control unit controls the transport unit such that the transport unit continuously transports the printing medium, and controls the heating portions such that a heating temperature of the first heating portion is lower than a heating temperature of the second heating portion.

3. The printing apparatus according to claim 1, wherein
the drying unit includes:
an air blowing unit that blows air from an air blowing port to a printing surface of the printing medium on which printing has been performed by the printing head; and
a suction unit in which a suction port is disposed downstream of the air blowing port in the transport direction on the transport path.

4. The printing apparatus according to claim 3, wherein
the air blowing port and the suction port are disposed to be wider than a width of the printing medium in a width direction intersecting the transport direction.

5. The printing apparatus according to claim 4, wherein
the air blowing unit includes an airflow heating unit that heats an airflow for blowing toward the printing surface, and blows a heated airflow from the air blowing port.

6. The printing apparatus according to claim 1, wherein
the heating portions are polyimide heaters.
